(19) United States
(12) Patent Application Publication
(10) Pub. No.: US 2003/0123724 A1
(43) Pub. Date: Jul. 3, 2003

(54) Schematic colorization system

(75) Inventors: Gregg A. McClelland, Peoria Heights, IL (US); J. Ryan Hubbard, Tremont, IL (US); Sammy J. Graham, East Peoria, IL (US); James V. Dornberger, Canton, IL (US); William J. Gardner, Pekin, IL (US); Earl A. Riley, Washington, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/026,758

(22) Filed: Dec. 27, 2001

(51) Int. Cl. G06K 9/00

(52) U.S. Cl. 382/165

(57) ABSTRACT

A method is provided for colorizing an electronic schematic including a set of features, wherein each feature includes one or more elements. First, a set of features to be colorized on the schematic is identified. A color scheme is established that includes a color associated with each of the features. An element is associated with one of the features. The element is then automatically colorized based on the color scheme.

### TECHNICAL FIELD

The present invention relates generally to the preparation and publication of schematic drawings and, more particularly, to a system and method for colorizing a drawing.

### BACKGROUND

Detailed schematic drawings are common in many industries. For example, schematic drawings are typically created by engineers when designing a new system or feature, for example, for a vehicle or a machine. These schematic drawings may include, for example, electrical components as well as interconnecting wiring. The schematics are quite detailed, often several hundred wires per drawing, and can range in size anywhere from a normal sheet of paper to a sheet measuring several feet in both length and width. The schematic drawings may be used in the manufacturing of the vehicle or machine. Further, schematic drawings are often provided to service technicians as reference guides when repairing or maintaining the vehicle or machine.

Particularly for service technicians, and other persons who may not have regular exposure to these complicated drawings, it is helpful to provide a colorized version of the schematic to assist in finding high-level systems or circuits. Each system in a vehicle or machine may be assigned a particular color. For example, all components and wires associated with the braking system may be colored red, and all components and wires associated with the throttle control system may be colored green. The colorized schematic may make it easier for the technician to locate the components and wiring associated with a particular system the technician is trying to repair or maintain.

One known method for colorizing schematics is as follows. An electronic engineering schematic file is obtained. If the schematic is in a computer-aided design (CAD) format, the schematic may then be converted to another format in preparation for printing. For example, the file may be converted to a publishing software format, such as Adobe Illustrator, which converts the CAD format into a standard graphic format. A hard copy of the file is then printed. A color legend is defined for the schematic, and the hard copy is manually colored using highlighter pens and/or colored markers. The manually colored copy is reviewed for errors. The steps of manually coloring the hard copy and reviewing the manually colored copy are typically done by persons associated with the engineering department, who have a detailed knowledge of the system design.

Based on the manually colored copy, the Illustrator file may then be colored. This colorization may be done by dividing the schematic into a series of grids and coloring the components and wire segments in each grid one at a time. The colored Illustrator file is then compared to the manually colored copy for accuracy. The steps of colorizing the Illustrator file and comparing the colored Illustrator file is often done by an outside vendor with expertise in the publishing field.

Prior to the actual publication of the schematic, as well as any time that revisions are made, the following additional steps are required. An updated electronic engineering schematic file is obtained, and a hard copy is printed. The hard copy of the revision is compared to the hard copy of the original schematic file. If there are few changes, it may be possible to make changes to the colorized Illustrator file. If the changes are extensive, however, it is necessary to begin the process anew. As a last step before publication, the colorized Illustrator file is reviewed a final time.

The above process is time-consuming and expensive. For example, to colorize an original drawing using this process may take many months and hundreds of man-hours. Further, the use of an outside vendor for the colorizing of the Illustrator file is expensive. It is also cumbersome to make last-minute revisions to the schematics, since a minor revision may require starting the colorization process from the beginning.

The present invention is directed to overcoming one or more of the problems or disadvantages associated with the prior art.

### SUMMARY OF THE INVENTION

A method is provided for colorizing an electronic schematic including a set of features, wherein each feature includes one or more elements. First, a set of features to be colorized on the schematic is identified. A color scheme is established that includes a color associated with each of the features. An element is associated with one of the features. The element is then automatically colorized based on the color scheme. An aspect of the present invention includes providing a computer-readable medium including instructions for performing the above-described method. Another aspect of the present invention includes a system having a colorization module configured to perform the steps of the above-described method.

Further, another system is provided for preparing and colorizing an electronic schematic including a set of features, wherein each feature includes one or more elements. The system includes a processor and a memory. The memory includes a computer-aided design module for preparing the electronic schematic and a colorization module for colorizing the electronic schematic.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate an exemplary embodiment of the invention and together with the description, serve to explain the principles of the invention.

In the drawings:

FIG. 1 is a block diagram of a schematic colorization system consistent with an exemplary embodiment of the present invention;

FIG. 2 is a flow chart of an exemplary embodiment of a method, consistent with the present invention, for colorizing an original schematic drawing; and

FIG. 3 is a flow chart of an exemplary embodiment of a method, consistent with the present invention, for revising an already colorized schematic.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

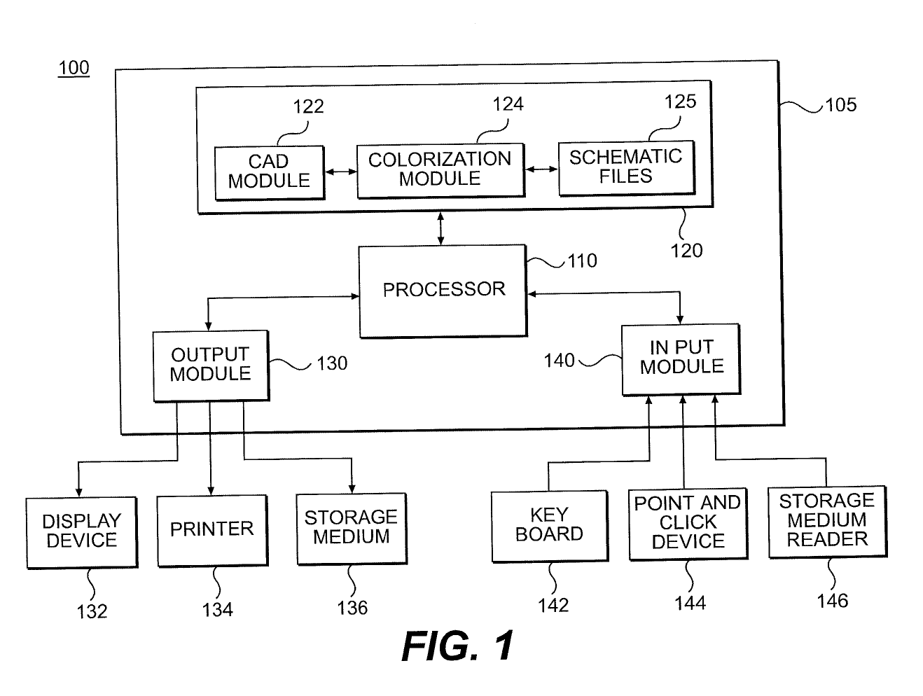

FIG. 1 illustrates an exemplary colorization system 100 consistent with the present invention. Colorization system 100 may be used to colorize schematics, including engineering schematics, blueprints, diagrams, or any other illustration where color may be associated with an aspect of the design. Colorization system 100 may include a computer 105. Computer 105 may include a processor 110, a memory 120, an output module 130, and an input module 140. Processor 110 may perform various aspects of schematic colorization, based on instructions stored in memory 120. Further, processor 110 may provide colorized schematics to output module 130 for review or publishing. Processor 110 may also receive information for use while colorizing schematics from input module 140.

Memory 120 may include a computer-aided design (CAD) module 122, a colorization module 124, and schematic files 125. CAD module 122 may include instructions used by processor 110 to create the original engineering schematic. Alternatively, the engineering schematic may be created using another type of design system. In another embodiment, CAD module 122 may be located separately from colorization system 100. In one exemplary embodiment, CAD module 122 may be implemented using Pro-Engineer software. Colorization module 124 may include instructions used by processor 110 to colorize the original engineering schematic created by CAD module 122. For example, colorization may involve establishing a color scheme by choosing a color to be associated with one or more features in the schematic. A feature may be broadly defined to include any system, component, function, circuit, or other aspect of the schematic. Further, colorization may include selecting an element associated with a particular feature and coloring that element based on the color scheme. An element may be defined to include any portion, component, function, circuit, or other aspect of a feature. For example, in an electrical schematic, a feature may include a particular circuit and elements of that feature may include wires and electrical components. In another example, in a plumbing schematic, a feature may include a particular route of piping and elements of that feature may include the pipe units that constitute the route. Colorization module 124 may be implemented using software designed to interact with CAD module 122. Alternatively, CAD module 122 and colorization module 124 may be part of the same software package. Original engineering schematic drawings and colorized schematic drawings may be stored as schematic files 125 in memory 120.

Output module 130 may receive colorized schematics from processor 110 to be reviewed or published. Output module 130 may be connected to a display device 132, a printer 134, or a storage medium 136. Display device 132, for example, may include a computer monitor, LCD panel, touch screen display, or other conventional display on which the colorized schematic may be reviewed. Printer 134 may include an inkjet printer, laser printer, or any other color printing system from which hard copies of the colorized schematics may be obtained for review or publication. Storage medium 136 may include a disk, CD ROM, or other conventional storage medium on which the colorized schematic may be stored and/or transferred to another computer for review or publication. Alternatively, colorized schematics may be transferred to another computer for review or publication by hard-wire connections, such as LAN technology, Internet connections, or wireless technology. Storage medium 136 may also be used to store colorization information, such as a color legend or a colorization table. A color legend may include a list of systems, features, elements, or combinations thereof in an engineering schematic, such as a braking circuit or a throttle control circuit and the color associated with each system. A colorization table may include a list of systems, features, elements, or combinations thereof, such as a list of wires and components, identified by number or name, and the color associated with each wire or component. Alternatively, a colorization table may include a list of wires and components associated with each system, which can then be colorized using the relationship between the system and the color legend.

Input module 140 may receive instructions from an operator for the colorization of the schematic. For example, input module 140 may receive information for establishing a color scheme or for associating a particular wire or component with one of the colors in the color scheme. Input module 140 may receive inputs from, for example, a keyboard 142, a point-and-click device 144, or a storage medium reader 146. Keyboard 142 may be used to input text or other data to establish the color scheme or color selected wires or components, for example, by identifying the wire or component by name or number. Point-and-click device 144 may include, for example, a mouse, a joystick, or any other suitable device. Point-and-click device 144 may be used, for example, to select a color from the color scheme by clicking that color in a color legend, and then colorizing a wire by then clicking on the desired wire. Alternatively, point-and-click device 144 may be used for colorizing a wire, for example, by dragging-and-dropping the desired color from the color legend onto the selected wire. Storage medium reader 146 may be used to read previously stored colorization information, such as color legends and/or tables associating wires or systems with colors.

Computer 105 may be implemented in various environments to provide the tools for colorizing the schematic drawings. Computer 105 may be hardware specifically constructed for performing various processes and operations of the invention or may include a general purpose computer or computing platform selectively activated or reconfigured by program code to provide the necessary functionality.

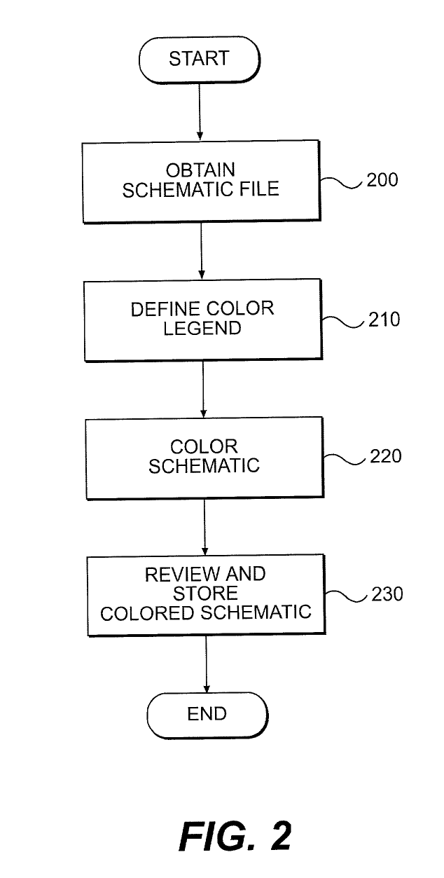

FIG. 2 illustrates an exemplary flow chart of an method for colorizing an engineering schematic drawing, instructions for which may be included in colorization module 124 and performed by processor 110. First, a schematic file is established (step 200). The schematic file may be obtained from the CAD module 122 or from schematic files 125 in memory 120. This schematic file may include an original or modified engineering schematic.

Next, a color legend is established (step 210). For example, an existing color legend may be accessed and imported into colorization system 100. Alternatively, a new color legend may be defined within colorization system 100. This step may include identifying one or more features illustrated in the schematic file and associating a color with each identified feature. Alternatively, a predefined list of feature and associated colors may be provided. In one embodiment, features that do not appear on the instant schematic may be removed from the color legend. The color legend may include a table listing one or more features and a color associated with each identified feature and/or may include a visual representation of the legend. For example, a visual representation of the legend may include a block of the associated color next to each feature in a list or the text of the list itself may be colored so that the name of each system is displayed in its associated color. While each feature in a schematic may be associated with an individual color, it is also contemplated that multiple features may be associated with the same color or that only certain features in a schematic may be associated with a color.

The schematic drawing may then be automatically colorized, based on the color legend (step 220). As used in throughout this description, automatically means in an automated, or semi-automated manner, with a limited portion or no portion of the task being provided by the operator. Further, automatically does not necessarily mean occurring immediately. Because the colorization may be done in conjunction with CAD module 122, it is possible to colorize an entire element, such as a wire or component, regardless of bends in the wire, rather than just a segment. In one exemplary embodiment, the drawing may be colorized by first selecting the desired color in the color legend, for example, by clicking the color in the visual representation, and then clicking anywhere along the wire to be colored. The entire wire is then colorized. In another embodiment, the drawing may be colorized by dragging-and-dropping the wire onto the desired color in the color legend. In yet another embodiment, a wire may be colored by entering a number or name associated with that wire and then entering a number or name associated with the desired color (e.g., “Brake_wire_{—}1, Red”). In one embodiment, a list may be established for each color. Within each list, an element name or number may be entered into the list, and the element may be automatically colorized. In one exemplary embodiment, selecting a wire to be colorized may result in colorization between a component, such as an electronic control module (ECM), and a harness or bulkhead connector. Alternatively, selecting a wire to be colorized may result in colorization of the wire extending through the bulkhead or through the component or end of the broadest component, over the entire length of the wire.

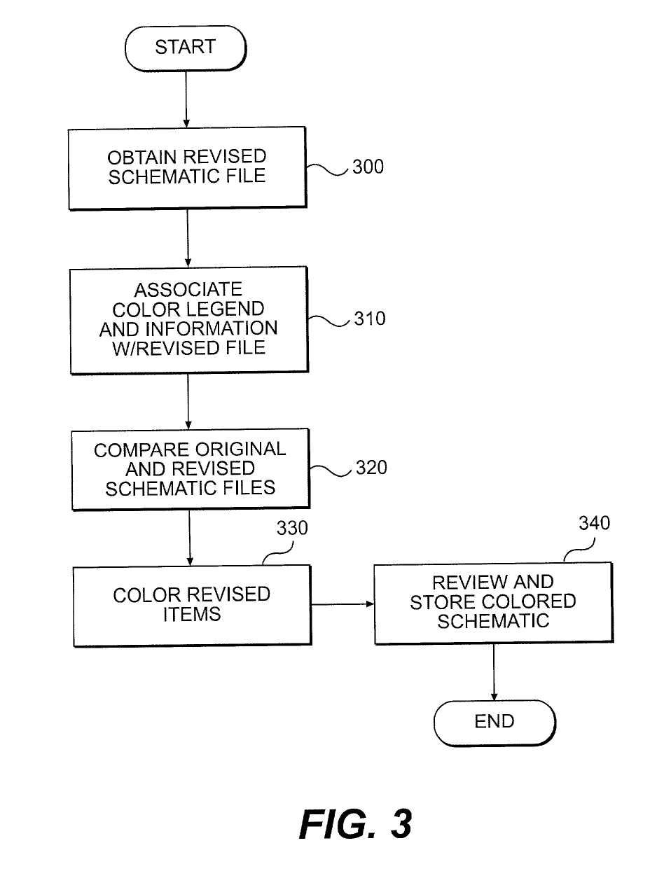

In one embodiment, the colorized schematic is then reviewed and stored (step 230). The review process may include viewing the colorized schematic in a CAD environment or may include printing a hard copy of the colorized schematic. In a CAD environment, the reviewer may be able to pan across the schematic or zoom into an area of the schematic to more efficiently review the colorized schematic. The review process may occur on the same computer on which the schematic was created and/or the schematic was colorized, or the colorized schematic may be saved to a storage medium and/or transferred to another computer for review. Storing the colorized schematic may include storing the color legend and a table providing a color associated with each wire or component. Alternatively, storing the colorized schematic may include storing the color legend and a table providing a list of wires and components associated with each system. The stored colorized schematic can be used later during the revision process, as described with respect to FIG. 3.

FIG. 3 illustrates an exemplary flow chart of a method for revising a colorized schematic drawing, instructions for which may be included in colorization module 124 and performed by processor 110. During the revision process, the stored colorized schematic created in step 230 of FIG. 2 will be referred to as the original colorized schematic. First, a revised schematic file is obtained (step 300). The revised schematic file may be obtained from the CAD module 122 or from schematic files 125 in memory 120. Alternatively, the revised schematic file may be received from input module 140, for example, via storage medium reader 146.

Next, the color legend and colorization information of the original colorized schematic maybe associated with the revised schematic file (step 310). For example, the colorization information may include a list of each element, identified by name or number, and their associated color. Associating this information with the revised schematic will cause the elements that remain unchanged in the revision process to be colorized as in the original colorized schematic. Alternatively, the colorization information may include a list of features in the schematic accompanied by a list of elements associated with each system. Any of the elements that remain unchanged in the revised schematic will then be colorized based on the colorization information from the original colorized schematic and the color legend, associating a color with each feature.

In one embodiment, the original colorized schematic may then be compared to the revised schematic drawing (step 320). Based on the results of step 310, it may be easy to determine which features and/or elements have been added or changed in the revision process. Alternatively, CAD module 122 may have the ability to compare two schematic drawings and provide a list of features and/or elements that have been added, deleted, or modified

Features and elements that have been revised are then colorized according to the color legend (step 330). Colorization of the revised features and/or elements may be performed using any of the methods detailed above with respect to step 220. The colorized revised schematic is then reviewed and stored (step 340), similar to step 230 above.

It should be understood that systems and methods consistent with the present invention are applicable for fields other than engineering schematics. In particular, any field that produces detailed drawings, where individual systems, features, elements, or combinations thereof can be highlighted, may provide potential uses for the present invention. For example, systems and methods consistent with the present invention may be used with computer-aided architectural drawings to highlight systems such as plumbing, electrical wiring, blue prints and any other system where associating a color with a function, feature, element, component, or system may be useful.

Industrial Applicability

A system and method are provided to more efficiently produce and publish colorized schematic drawings, such as engineering-type drawings. By colorizing the schematic in conjunction with a CAD module, it is possible to view the schematic as a series of wires and components, rather than artwork, and thus, the wires can be colorized in their entirety with a single action, rather than manually and then by grid-to-grid colorization. Further, rather than requiring a schematic to begin the colorization process months in advance, it is possible to reduce the lead time for colorizing an original schematic to a number of weeks. Thus, the present invention reduces the time and cost associated with producing an original colorized schematic.

Systems and methods consistent with the present invention also reduce the amount of time and money associated with revising the colorized schematics. Because conventional techniques require that schematics enter the colorization process some three months prior to publication, revisions were very common. With the present invention, the lead time is cut significantly, thus decreasing the likelihood that extensive revisions may be done at the time the schematic begins to be colorized. Additionally, the revision process itself is more efficient. The present invention does not require starting from an original schematic if the changes are extensive. The same color legend and colorization information that had been applied to the original colorized schematic may be associated with the revised schematic. The original and revised schematic may be compared electronically, and only the revised features and elements need to be re-colorized.

In addition to saving time and money, systems and methods consistent with the present invention also lead to improved integrity of colorized schematics, as the conventional process involving essentially two steps of manual colorization are prone to human error. By automating this process, it is more likely that an accurate schematic may result. Further, because of the ability to re-use color legends, and even some colorization information, it is possible to create a series of uniformly colorized schematics, also increasing integrity in the series of schematics as a whole.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method of colorizing an electronic schematic including at least one feature comprising the steps of:
identifying a set of features associated with the electronic schematic to be colorized;
establishing a color scheme, wherein the color scheme includes a color associated with at least one of the features; and
automatically colorizing the feature based on the color scheme.

2. The method of claim 1, wherein each feature includes one or more elements, and wherein the step of automatically colorizing the feature includes:
associating an element with one of the features; and
automatically colorizing the element based on the color scheme.

3. The method of claim 1, further including:
storing the colorized schematic in an electronic format.

4. The method of claim 3, further including:
obtaining a revised electronic schematic;
comparing the schematic to the revised electronic schematic to determine revised portions and non-revised portions of the revised electronic schematic;
colorizing the non-revised portions based on the stored colorized schematic;
associating an element from the revised portions with one of the features; and
automatically colorizing the element based on the color scheme.

5. The method of claim 2, wherein the step of associating an element with one of the features includes:
selecting a feature; and
selecting at least one element on the schematic to be associated with the selected feature.

6. The method of claim 5, wherein the step of selecting at least one element on the schematic includes:
selecting at least one element in a visual representation of the schematic.

7. The method of claim 5, wherein the step of selecting at least one element on the schematic includes:
entering one or more labels associated with the elements.

8. A computer-readable medium including instructions for performing a method of colorizing an electronic schematic including at least one feature comprising the steps of:
identifying a set of features on the schematic to be colorized;
establishing a color scheme, wherein the color scheme includes a color associated at least one of the features; and
automatically colorizing the feature based on the color scheme.

9. The computer readable medium of claim 8, wherein each feature includes one or more elements, and wherein the step of automatically colorizing the feature includes:
associating an element with one of the features; and
automatically colorizing the element based on the color scheme.

10. The computer readable medium of claim 8, further including the step of:
storing the colorized schematic in an electronic format.

11. The computer readable medium of claim 10, further including the steps of:
obtaining a revised electronic schematic;
comparing the schematic to the revised electronic schematic to determine revised portions and non-revised portions of the revised electronic schematic;
colorizing the non-revised portions based on the stored colorized schematic;
associating an element from the revised portions with one of the features; and
automatically colorizing the element based on the color scheme.

12. The computer readable medium of claim 9, wherein the step of associating an element with one of the features includes:
selecting a feature; and
selecting at least one element on the schematic to be associated with the selected feature.

13. The computer readable medium of claim 12, wherein the step of selecting at least one element on the schematic includes:
selecting at least one element in a visual representation of the schematic.

14. The computer readable medium of claim 12, wherein the step of selecting at least one element on the schematic includes:
entering one or more labels associated with the elements.

15. A system configured to colorize an electronic schematic including a set of features, the system comprising:
a processor; and
a memory, wherein the memory includes
a colorization module configured to colorize the electronic schematic.

16. The system of claim 15, wherein the memory further includes:
a computer-aided design module configured to prepare the electronic schematic.

17. The system of claim 16, wherein the colorization module is software configured to work with the computer-aided design module during colorization of the electronic schematic.

18. The system of claim 16, further including an output module for providing the colorized schematic to one or more of a display device, a printer, or a storage medium.

19. The system of claim 16, further including an input module for receiving inputs from one or more of a keyboard, a point-and-click device, or a storage medium reader.

20. The system of claim 16, wherein the colorization module is configured to enable the processor to perform the following steps:
identify a set of features on the original electronic schematic to be colorized;
establish a color scheme, wherein the color scheme includes a color associated with at least one of the features;
associate an element with one of the features; and
automatically colorize the element based on the color scheme.

21. The system of claim 17, wherein the colorization module is further configured to instruct the processor to further perform the following steps:
store the colorized schematic in an electronic format;
obtain a revised electronic schematic;
compare the electronic schematic to the revised electronic schematic determine revised portions and non-revised portions of the revised electronic schematic;
colorize the non-revised portions based on the stored colorized schematic;
associate an element from the revised portions with one of the features; and
automatically colorize the element based on the color scheme.

22. A system for colorizing an electronic schematic including at least one feature, the system comprising:
a colorization module for colorizing the original electronic schematic, wherein the colorization module is configured to perform the following steps:
identify a set of features on the electronic schematic to be colorized;
establish a color scheme, wherein the color scheme includes a color associated with each of the features; and
automatically colorize the feature based on the color scheme.

23. The system of claim 22, wherein each feature includes one or more elements, and wherein the step of automatically colorizing the feature includes:
associating an element with one of the features; and
automatically colorizing the element based on the color scheme.

24. The system of claim 22, wherein the colorization module is further configured to perform the following steps:
store the colorized schematic in an electronic format;
obtain a revised electronic schematic;
compare the electronic schematic to the revised electronic schematic to determine revised portions and non-revised portions of the revised electronic schematic;
colorize the non-revised portions based on the stored colorized schematic;
associate an element from the revised portions with one of the features; and
automatically colorize the element based on the color scheme.
